(19) United States
(12) Patent Application Publication
(10) Pub. No.: US 2003/0132017 A1
(43) Pub. Date: Jul. 17, 2003

(54) Method of manufacturing a cable sheath by extruding and cross-linking a composition based on silane-grafted polymer, and a cable including a sheath obtained by the method

(76) Inventor: Chantal Barioz, Lyon (FR)

Correspondence Address: SOFER & HAROUN, LLP, Suite 910, 317 Madison Avenue, New York, NY, 10017, US

(21) Appl. No.: 10/274,426

(22) Filed: Oct. 18, 2002

(30) Foreign Application Priority Data
Oct. 23, 2001 (FR) 01 14193

(51) Int. Cl. H01B 7/00

(52) U.S. Cl. 174/24; 264/171.14

(57) ABSTRACT

The present invention provides a method of manufacturing a cable sheath by extruding and cross-linking a composition based on a silane-grafted polymer, the method comprising the following steps:

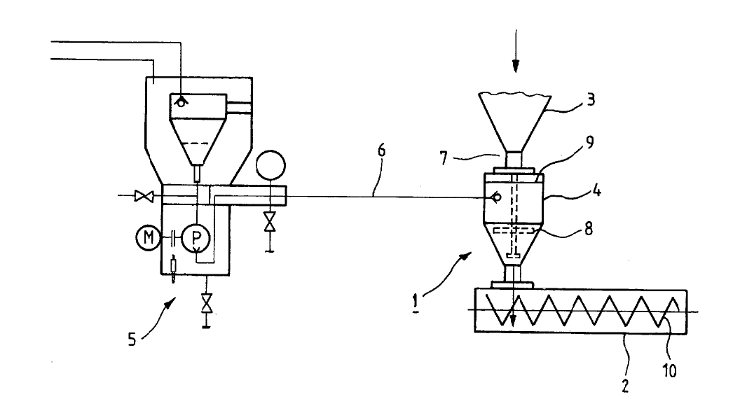

a) mixing the following compounds:

i) a thermoplastic base polymer or a mixture of thermoplastic base polymers;

ii) a first silane-based compound; and

iii) a generator of free radicals;

b) extruding said mixture onto a cable to obtain said sheath;

c) cross-linking said sheath;

d) prior to said cross-linking, incorporating a compound containing a secondary amine function; and

e) performing said cross-linking in the ambient atmosphere.

The present invention relates to a method of manufacturing a cable sheath by extruding and cross-linking a composition based on a silane-grafted polymer, and to a cable including a sheath obtained by the method.

Throughout the present text, the term “sheath” is used without distinction to designate either the electrical insulation of a cable or an outer protective sheath proper of a cable.

### BACKGROUND OF THE INVENTION

Silane-grafted polymers are well known, and they are used in particular for insulating and sheathing power cables for use at low, medium, high, and very high voltage. They have the advantage of possessing electrical insulation and mechanical strength properties that are particularly advantageous, with cross-linking increasing the mechanical strength and the temperature stability of the composition.

It is known that the physical properties of polymers can be modified by cross-linking polymer chains. Cross-linking by means of silane, and more generally cross-linking using one or more non-saturated olefinic alkoxysilanes as a cross-linking agent is a method in widespread use for cross-linking polymers. A known method of manufacturing cable sheaths out of silane-grafted polymers, and referred to as the Sioplas® method, is described in U.S. Pat. No. 3,646,155.

The method consists, in a first step generally referred to as “grafting”, in mixing a base polymer, in particular a thermoplastic polymer such as a polyolefin, e.g. polyethylene, with a solution containing the silane cross-linking agent and a free radical generator such as a peroxide. This provides silane-grafted polymer granules.

In a second stage of the method, generally referred to as compounding, the silane-grafted granules are mixed with inorganic fillers (in particular a fireproofing additive), waxes (working agents), and stabilizers (to prevent the sheath aging on the cable). This produces a compound.

Thereafter, in an extrusion third step, the compound is mixed with a coloring agent and a catalyst such as a metallic salt (e.g. a tin salt), in an extruder such as a screw extruder, and is then extruded onto a cable.

Finally, in a fourth step, cross-linking is triggered in the presence of a large quantity of water and by heating. This cross-linking step is commonly referred to as taking place “in-pool” or “in-sauna”.

The method is thus penalizing on an industrial scale since “in-pool” cross-linking needs to be performed as a subsequent operation on a finished cable, and it requires coiled cables to be placed in large tanks filled with water in order to obtain full cross-linking of the manufactured sheath. The efficiency with which cables manufactured in that way are produced is mediocre and manufacture requires installations that are large and expensive, which is very penalizing, industrially speaking.

### OBJECTS AND SUMMARY OF THE INVENTION

An object of the present invention is thus to develop a method of manufacturing a cable sheath by extruding and cross-linking a composition based on silane-grafted polymer that does not require a cross-linking step to be performed “in-pool” or “in-sauna”.

To this end, the present invention provides a method of manufacturing a cable sheath by extruding and cross-linking a composition based on a silane-grafted polymer, the method comprising the following steps:

a) mixing the following compounds:

i) a thermoplastic base polymer or a mixture of thermoplastic base polymers;

ii) a first silane-based compound; and

iii) a generator of free radicals;

b) extruding said mixture onto a cable to obtain said sheath;

c) cross-linking said sheath;

d) prior to said cross-linking, incorporating a compound containing a secondary amine function; and

e) performing said cross-linking in the ambient atmosphere.

In the present invention and quite surprisingly, it has been found in methods of the Sioplas® type that adding a compound containing a secondary amine function prior to cross-linking, i.e. either in the mixture or else after the grafting step during the compounding step, or indeed during the subsequent step of extrusion onto a cable, has the effect of causing the mixture to self-cross-link without needing any humidity to be added other than the presence of ambient humidity.

In a Sioplas® type method, the sheath obtained by the method of the invention can thus be cross-linked after 5 days in ambient air, whereas prior art sheaths require cross-linking for about 2 days in a pool heated to a temperature in the range 65° C. to 70° C. The compound containing the secondary amine function thus acts as a cross-linking catalyst.

Most advantageously, the compound containing a secondary amine function is incorporated during said extrusion.

It can also be incorporated during mixing.

In an implementation of the invention, the mixing step leads to a silane-grafted polymer and is followed by a compounding step during which at least one additive is added to the grafted polymer.

Under such circumstances, the compound containing a secondary amine function can be incorporated during the compounding step or during the extrusion step.

The compound containing a secondary amine function may be selected from secondary amines, such as, for example, dimethylamine, diethylenetriamine, heterocyclic secondary amines, and metallic salts thereof, or indeed from aminosilanes.

Advantageously, the compound containing a secondary amine function is selected from a second silane compound and a stabilizing additive.

Preferably, the compound containing a secondary amine function is contained in said composition at a concentration lying in the range 0.3 parts to 1 part per 100 parts of said mixture.

Preferably, the compound containing a secondary amine function is N-(n-butyl)-3-aminopropyltrimethoxysilane.

Preferably, the thermoplastic base polymer is selected from an ethylene vinyl acetate copolymer (EVA), an ethylene ethyl acrylate copolymer (EEA), an ethylene butyl acrylate copolymer (EBA), a polyethylene, an ethylene and unsaturated propylene terpolymer.

In an advantageous implementation, the first silane compound is selected from trimethoxysilane, vinyltrimethoxysilane, vinyltriethoxysilane, and vinyltricholorosilane.

By way of example, the free radical generator is a peroxide.

Advantageously, a catalyst for said cross-linking is also incorporated in said mixture, preferably a metallic salt such as a tin salt.

It is also possible to incorporate at least one additive in the mixture such as a stabilizer, a fireproofing filler, a working agent, or an antioxidant.

The invention also provides an electrical or optical cable having at least one extruded sheath obtained by the above method.

### BRIEF DESCRIPTION OF THE DRAWING

Other characteristics and advantages of the present invention appear from the following description of an implementation of the invention given purely by way of non-limiting illustration.

The sole FIGURE is a diagram of apparatus for implementing the method of the invention.

### MORE DETAILED DESCRIPTION

The method of the invention is described below with reference to the FIGURE in an implementation for manufacturing a sheath of an electric cable, and in particular, a power cable. As explained above, the term “sheath” is used to cover any cable layer obtained from a polymer material, regardless of whether it performs an electrically insulating function or acts as a mechanical protection sheath proper.

In the FIGURE, there can be seen apparatus 1 suitable for use in implementing the method of the invention which is of the Sioplas® type. The apparatus 1 comprises a continuous mixer device, i.e. the mixture coming from compounding is injected directly into the extruder. The apparatus 1 comprises an extruder 2 having a screw 10 and a hopper 3 disposed above the extruder 2 for the purpose of receiving a non-cross-linked silane-grafted polymer, e.g. in the form of granules. The mixer 4 is disposed between the hopper 3 and the extruder 2.

The silane-grafted polymer is previously obtained by mixing together and then heating: a base polymer; a silane compound; and a generator of free radicals, such as a peroxide.

The mixer 4 also has a feed pipe 6 opening out therein coming from a unit that forms a metering pump 5 and that is designed specifically to incorporate a certain number of additives into the silane-grafted polymer, such as an inorganic filler (e.g. a fireproofing filler), a working agent in the form of a wax, one or more stabilizers, etc. . . . . These stabilizers are delivered into the inside of the mixer 4 by means of an injector 7.

In the invention, these additives include a compound containing a secondary amine function. This compound may be constituted in particular by a second silane compound, containing a secondary amine function, or it may be a stabilizer containing such a function.

The term “stabilizer” is conventionally used to designate a compound that serves to prevent the cross-linked polymer from aging by depolymerizing. As a general rule it belongs to the category of antioxidants or of anti-ultraviolet (anti-UV) agents.

Adding the compound containing a secondary amine function in accordance with the invention serves to accelerate the cross-linking reaction of the silane-grafted polymer and thus serves to catalyze said reaction. In the invention, this acceleration makes it possible to avoid the subsequent cross-linking step “in-pool” as is necessary in prior art methods of the Sioplas® type.

A stirring mechanism 8 is disposed inside the mixer 4 and is driven by a drive mechanism 9.

The screw extruder 2 is a conventional extruder for extruding plastics material, having a screw 10 presenting a total ratio of length/diameter of about 26/1.

The still non-cross-linked compound reaches the extruder 2 directly from the mixer 4. On leaving the extruder 2, the desired sheath is obtained deposited on the cable that is to be coated (not shown).

At the outlet from the extruder 2, the resulting sheathed cable can be left in ambient air, and it is found to become cross-linked within a period of 5 days to 7 days.

The invention is illustrated below by giving two examples of compositions for cross-linking, one in accordance with the prior art (Example 1) and the other in accordance with the invention (Example 2).

### EXAMPLE 1

A composition A was prepared using the above-described method, the composition containing:

100 parts EVA 1% grafted with a silane mixture (97% vinyltrimethoxysilane and 3% peroxide);

170 parts of alumina trihydrate Al(OH)₃ as a fireproofing filler;

3 parts of wax as a working agent;

1 part of UV stabilizer; and

2 parts antioxidant.

The extruded sheath obtained from this compound was cross-linked by placing the cable in a pool at 70° C. for 24 hours.

### EXAMPLE 2

The above-described method was used to compare a composition B containing:

100 parts EVA 1% grafted with a silane mixture (97% vinyltrimethoxysilane and 3% peroxide);

170 parts of alumina trihydrate Al(OH)₃ as a fireproofing filler;

3 parts of wax as a working agent;

1 part of UV stabilizer;

2 parts antioxidant; and

0.5 parts of Dynasilan 1189 stabilizer sold by the supplier DEGUSSA and constituting a silane compound containing a secondary amine function: N-(n-butyl)-3-aminopropyltrimethoxysilane.

The extruded sheath obtained from this composition was cross-linked in ambient air after 5 days.

It should also be observed that the mechanical and electrical characteristics of the sheath obtained using composition B were similar to those obtained using composition A, i.e. composition B satisfies the requirements for use in power cables.

Naturally, the present invention is not limited to the implementation described above.

Firstly, it is preferable to introduce the compound containing a secondary amine function in accordance with the invention into the extruder so as to avoid the grafted polymer beginning to cross-link prior to being worked by extrusion. Nevertheless, the compound containing a secondary amine function can also be introduced either during mixing of the polymer with the free radical generator and the silane compound used for grafting purposes, or else during the subsequent step of compounding. More generally, it can be introduced at any time prior to cross-linking.

Furthermore, the implementation of the method of the invention is described above using continuous mixer apparatus, but naturally the method of the invention could equally well be implemented using a discontinuous mixer, i.e. the step of compounding the silane-grafted polymer could be performed in a mixer that is not connected to the screw extruder.

The compound containing a secondary amine function may be a stabilizer, as described above, or it may be a second silane compound, however it could also be any additive capable of containing a secondary amine function.

In the invention, it is also possible to add together with the usual additives a small quantity of a cross-linking catalyst such as a metallic salt, and in particular a tin salt such as tin dibutyl dilaurate, for example, or indeed a titanate. This further accelerates the cross-linking reaction.

The method of the invention is described above for a composition based on a single base polymer, however the method of the invention could also be implemented using a composition comprising a mixture of base polymers.

Furthermore, the method of the invention is described using a liquid silane compound for grafting on the base polymer, however it is also possible in the context of the invention to use silane compounds in the form of solid encapsulates as described in document EP-0 426 073.

Finally, any means may be replaced by equivalent means without going beyond the ambit of the invention.

What is claimed is:

1/ A method of manufacturing a cable sheath by extruding and cross-linking a composition based on a silane-grafted polymer, the method comprising the following steps:
a) mixing the following compounds:
i) a thermoplastic base polymer or a mixture of thermoplastic base polymers;
ii) a first silane-based compound; and
iii) a generator of free radicals;
b) extruding said mixture onto a cable to obtain said sheath;
c) cross-linking said sheath;
d) prior to said cross-linking, incorporating a compound containing a secondary amine function; and
e) performing said cross-linking in the ambient atmosphere.

2/ A method according to claim 1, wherein said compound containing a secondary amine function is incorporated during said extrusion.

3/ A method according to claim 1, wherein said compound containing a secondary amine function is incorporated during said mixing.

4/ A method according to claim 1, wherein said mixing step provides a silane-grafted polymer and is followed by a compounding step during which said at least one additive is added to said grafted polymer, said compounding step preceding said extrusion step.

5/ A method according to claim 4, wherein said compound containing a secondary amine function is incorporated during said compounding step or during said extrusion step.

6/ A method according to claim 1, wherein said compound containing a secondary amine function is selected from a second silane compound and a stabilizing additive.

7/ A method according to claim 1, wherein said compound containing a secondary amine function is contained in said composition at a concentration lying in the range 0.3 parts to 1 part per 100 parts of said mixture.

8/ A method according to claim 1, wherein said compound containing a secondary amine function is N-(n-butyl)-3-aminopropyltrimethoxysilane.

9/ A method according to claim 1, wherein said thermoplastic base polymer is selected from an ethylene vinyl acetate copolymer, an ethylene ethyl acrylate copolymer, an ethylene butyl acrylate copolymer, a polyethylene, an ethylene and unsaturated propylene terpolymer.

10/ A method according to claim 1, wherein said first silane compound is selected from trimethoxysilane, vinyltrimethoxysilane, vinyltriethoxysilane, and vinyltricholorosilane.

11/ A method according to claim 1, wherein said generator of free radicals is a peroxide.

12/ A method according to claim 1, wherein a catalyst for said cross-linking is also incorporated in said mixture, preferably a metallic salt such as a tin salt.

13/ A method according to claim 1, wherein at least one additive selected from a stabilizer, a fireproofing filler, a working agent, and an antioxidant is also incorporated in said mixture.

14/ An electrical or optical cable, comprising at least one extruder sheath obtained by the method according to claim 1.
